(19) United States
(12) Patent Application Publication
(10) Pub. No.: US 2026/0204122 A1
(43) Pub. Date: Jul. 16, 2026

(54) ARTICLE SUPPLY APPARATUS

(71) Applicant: BANDAI CO., LTD., Tokyo (JP)

(72) Inventors: Hajime KONDO, Tokyo (JP); Tatsushi IKARASHI, Tokyo (JP); Yoshiaki TATSUKI, Tokyo (JP); Nobuo KUROKAWA, Tokyo (JP)

(21) Appl. No.: 19/565,496

(22) Filed: Mar. 12, 2026

Related U.S. Application Data
(63) Continuation of application No. PCT/JP2024/041811, filed on Nov. 26, 2024.

(30) Foreign Application Priority Data
Nov. 30, 2023 (JP) 2023-203082

(51) Int. Cl. G07F 9/04; G07D 5/00

(52) U.S. Cl. CPC G07F 9/04; G07D 5/00

(57) ABSTRACT

An article supply apparatus 1 includes: an insertion portion 5 to which a coin C is insertable; a holding portion 25 which is capable of holding the coin C that is inserted; a setting portion 28 which is capable of setting a number of at least one coin C capable of being held in the holding portion; a discharge portion 29 which is capable of discharging the coin C that is inserted; and a control portion capable of controlling whether or not to discharge the coin C that is inserted, and the control portion controls the coin C that is additionally inserted to be discharged to the discharge portion 29, on a condition that the holding portion is holding a set number of coins C.

The contents of the following patent application(s) are incorporated herein by reference:

NO. 2023-203082 filed in JP on November 30, 2023, and

NO. PCT/JP2024/041811 filed in WO on November 26, 2024.

### BACKGROUND

### 1. TECHNICAL FIELD

The present invention relates to an article supply apparatus.

### 2. RELATED ART

In the related art, there are various types of article supply apparatuses (vending machines) for automatically selling products. The article supply apparatus is provided with a function to remove an excess coin (metal coin) in coins required as price payment for purchasing products. For example, Patent Document 1 discloses an excess coin removal apparatus for a change tube included in a vending machine or the like, which removes overflowing excess coins to one side outside a tube, in which an elastic body such as sponge rubber is attached to a sliding bottom surface of an excess coin removal member, or the sliding bottom surface itself is formed of the elastic body, or the like, thereby causing elastic deformation on the sliding bottom surface of the excess coin removal member.

### Related Art Documents

### Patent Document

Patent Document 1: Japanese Patent Application Publication No. S48-34598

### BRIEF DESCRIPTION OF THE DRAWINGS

FIG. 1 is a perspective view showing an appearance of an article supply apparatus of one aspect of the present invention.

FIG. 2 is a schematic cross-sectional view showing an internal structure of the article supply apparatus in FIG. 1.

FIG. 3 is a perspective view of a coin insertion unit shown in FIG. 2, as viewed from a right side.

FIG. 4 is a perspective view of the coin insertion unit shown in FIG. 2, viewed from a left side.

FIG. 5 is an enlarged perspective view of a sorting portion shown in FIG. 3.

FIG. 6 is a schematic cross-sectional view of a vicinity of the sorting portion as viewed from a rear side toward a front side of the apparatus.

FIG. 7 is a schematic perspective view showing an example when a coin is discharged.

FIG. 8 is a schematic perspective view showing another example when the coin is discharged.

### DESCRIPTION OF EXEMPLARY EMBODIMENTS

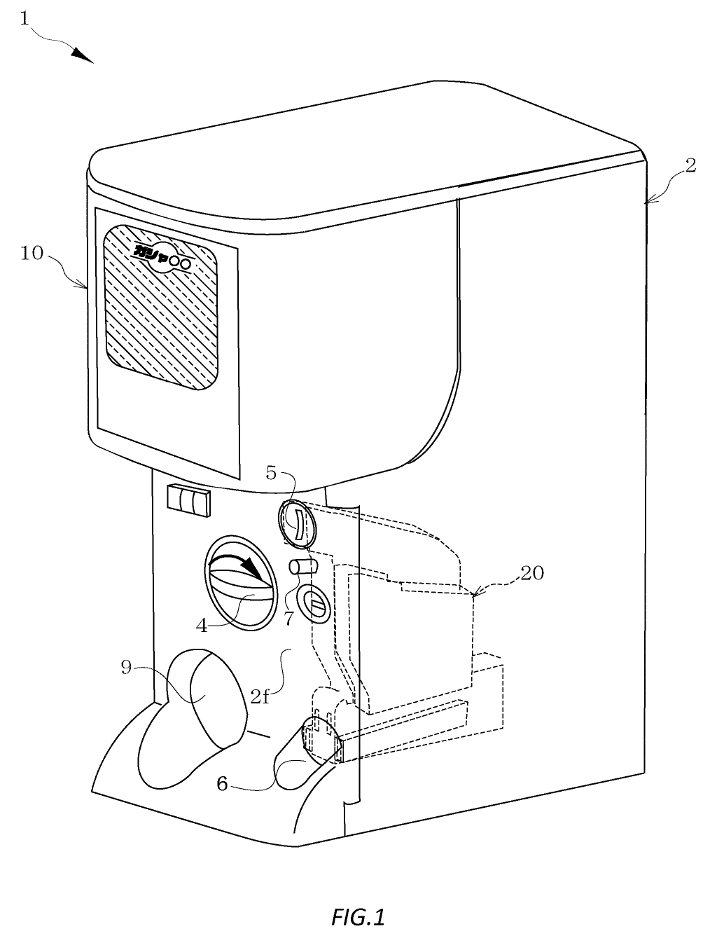

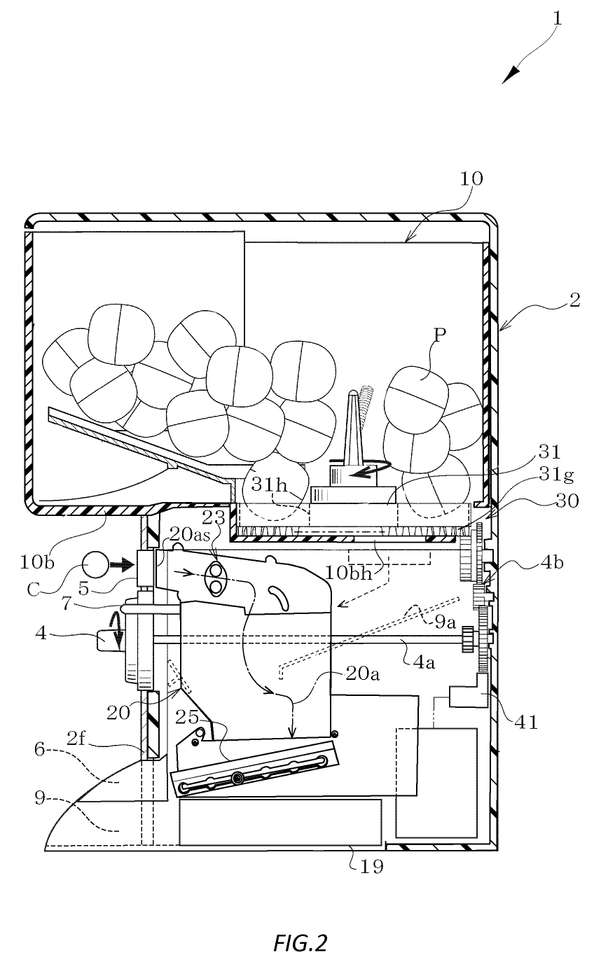

An article supply apparatus which is one aspect of the present invention will be described below with reference to the figure. FIG. 1 is a perspective view showing an appearance of an article supply apparatus 1 of the present aspect, and FIG. 2 is a schematic cross-sectional view showing an internal structure of the article supply apparatus 1.

The article supply apparatus 1 shown in FIG. 1 and FIG. 2 is an apparatus which is capable of supplying an article P of a capsule case of a spherical shape, in which toys or parts are accommodated, for example. More specifically, the article supply apparatus 1 includes: an accommodation portion 10 which is capable of accommodating a plurality of articles P in a random arrangement; a supply portion 30 which has a rotation disk 31 that is provided rotatably at a bottom portion 10b of the accommodation portion 10 and that is capable of randomly selecting and supplying the articles P one by one; and a lock portion 41 which locks the supply portion 30 to be inoperable, and the lock portion 41 is driven to release the lock on the condition that a coin C as a price is paid from an insertion portion 5. Then, in an unlocked state, an operation portion 4 provided on a front surface 2f is operated to rotate. In this manner, a gear train 4b provided at an edge side of a shaft 4a of the operation portion 4 rotates, and the rotation disk 31 is rotated via a rack gear 31g thereof. The article P held in a holding hole 31h of the rotation disk 31 falls at a passage hole 10bh provided in the bottom portion10b, and is supplied to a dispensing outlet 9 via an article passage portion 9a.

In the article supply apparatus 1, a coin insertion unit 20 is provided on the right side of the operation portion 4 (right side when the apparatus is faced). This coin insertion unit 20 is connected to the insertion portion 5 provided on the front surface 2f of a main body portion 2. Then, the coin C inserted from the insertion portion 5 passes through a passage portion 20a formed inside the coin insertion unit 20, and falls into and is held in a holding portion 25 on a lower side of the unit. In addition, in a case where a valid coin is inserted, when a predetermined amount is inserted and a predetermined operation is performed, the coin C held in the holding portion 25 is accommodated in a coin accommodation portion 19 provided, for example, below the holding portion 25. On the other hand, a configuration is made such that when the coin C that is not a valid coin, such as a counterfeit coin, is inserted, it is retained and captured at a movement regulation portion 23 provided in the passage portion 20a. That is, a first holding portion 25a and a second holding portion 25b are configured to hold only a proper valid coin and not to hold an improper counterfeit coin.

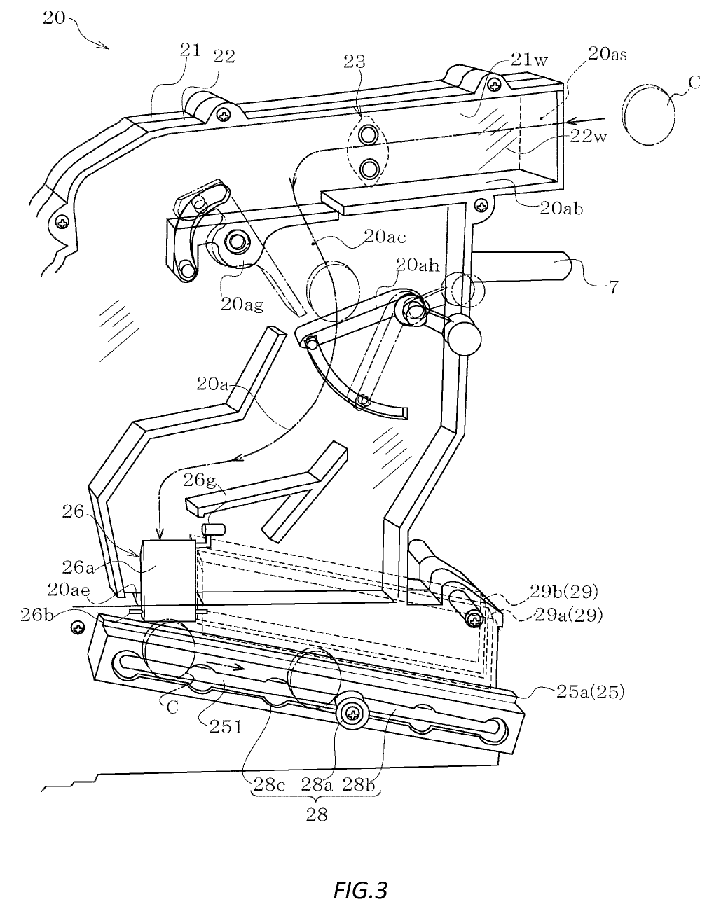

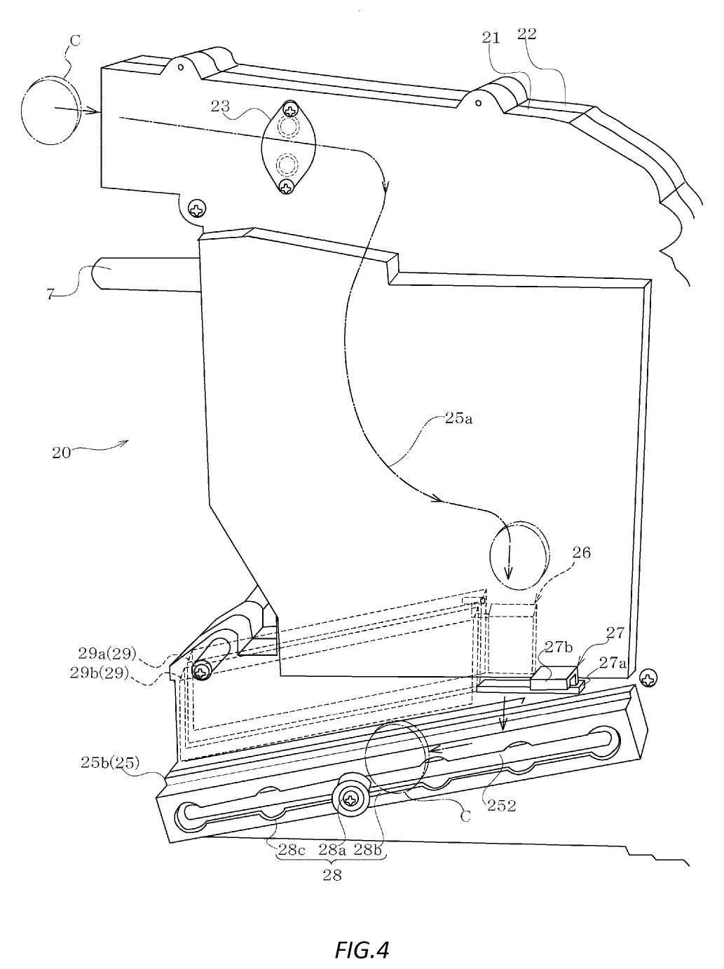

FIG. 3 is a perspective view of the coin insertion unit 20 shown in FIG. 2, as viewed from a right side. FIG. 4 is a perspective view of the coin insertion unit shown in FIG. 2, viewed from a left side. As shown in FIG. 3, the coin insertion unit 20 is a thin unit in which, for example, a left half case 21 and a right half case 22 are combined from the left and right direction, and left and right side walls thereof, which are a first side wall portion 21w and a second side wall portion 22w, face each other closely to form an internal space. Unlike the left half case 21 including the first side wall portion 21w, the right half case 22 including the second side wall portion 22w is formed, for example, of a light-transmitting material, and is configured such that the inside of the unit can be seen, as illustrated.

The coin insertion unit 20 has the passage portion 20a formed therein, from a start end portion 20as (right upper side in the Figure) connected to the insertion portion 5 to which the coin C is inserted, to an opening 20ae at a terminal end portion. The passage portion 20a is configured such that the coin C moves by gravity. For example, an initial coin introduction part including the start end portion 20as is provided with an inclination portion 20ab such that the coin C rolls, and is provided with a falling portion 20ac on a rear side of the inclination portion 20ab. The falling portion 20ac is provided with a first swing plate 20ag on an upper portion and a second swing plate 20ah on a lower portion; and both swing plates 20ag, 20ah rotate when the coin C is placed thereon, and assist the fall of the coin C and guide a movement direction of the coin C.

The opening 20ae at the terminal end portion of the passage portion 20a serves as an entrance to the holding portion 25 which holds the coin C. As shown in FIG. 3 and FIG. 4, the holding portion 25 is provided with the first holding portion 25a on a front side of the unit (right side when viewed from the front of the apparatus), and is provided with the second holding portion 25b having the same structure on a back side of the unit (left side when viewed from the front of the apparatus), and they face each other at positions on the front and back sides. Both of the first holding portion 25a and the second holding portion 25b are configured to be capable of holding the coin C. In addition, the sorting of the coins C into the first holding portion 25a and the second holding portion 25b is performed by a sorting portion 26 provided across an inside and an upper side of the opening 20ae.

As illustrated, the first holding portion 25a and the second holding portion 25b include a first passage portion 251 and a second passage portion 252 which are inclined (inclined with respect to the horizontal direction) downward toward a front surface 2f side (refer to FIG. 2). That is, the configuration is made such that the coin C which falls from the opening 20ae is movable within the first passage portion 251 and the second passage portion 252 toward the front surface 2f side by its own weight.

In addition, it is possible to determine setting of the number of coins C that are held in the first passage portion 251 and the second passage portion 252, by a setting portion 28 which is capable of engaging a movement of the coin C in an inclination direction. For example, the setting portion 28 has a slide opening 28b of a slit shape which is formed along the first passage portion 251 and the second passage portion 252 and is opened to an outer surface, and is provided with a position setting pin 28a which is movable in this slide opening 28b and protrudes into both passage portions 251, 252.

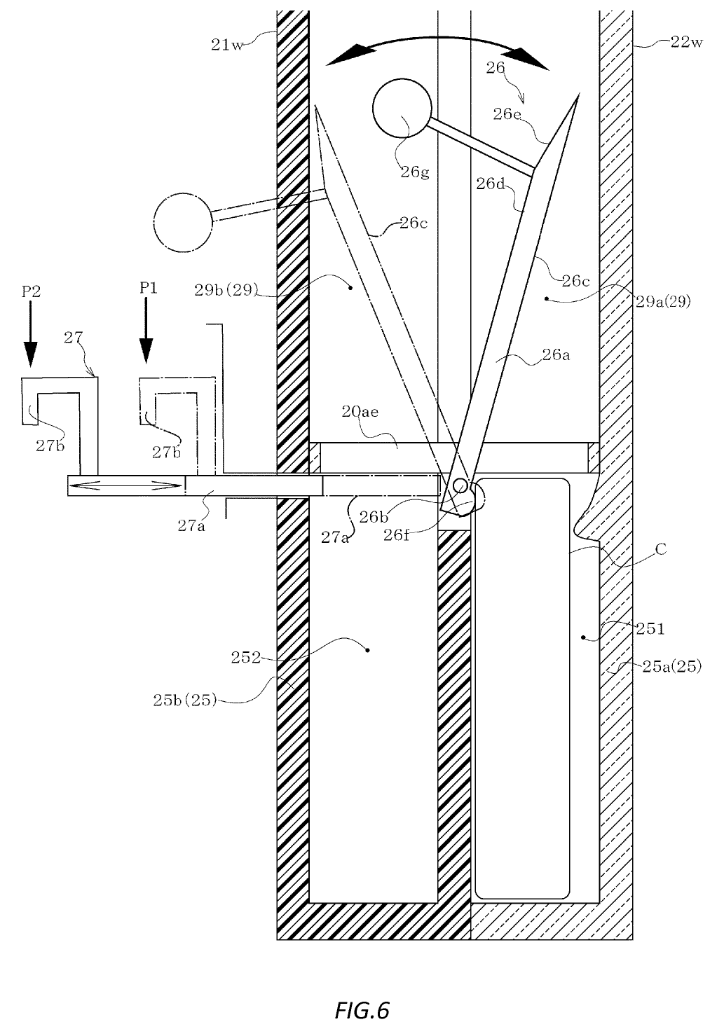

Further, the position setting pin 28a is configured to be capable of engaging in a plurality of large- diameter opening portions 28c which are formed at predetermined intervals in the slide opening 28b. That is, by engaging the position setting pin 28a in a predetermined large-diameter opening portion 28c, it is possible to set the number of coins C to a predetermined number. In addition, for the first holding portion 25a, a configuration is made such that the last coin C of a prescribed number of coins is positioned at a lower portion of the sorting portion 26 and contacts the lower portion of the sorting portion 26, as described later (refer to FIG. 6).

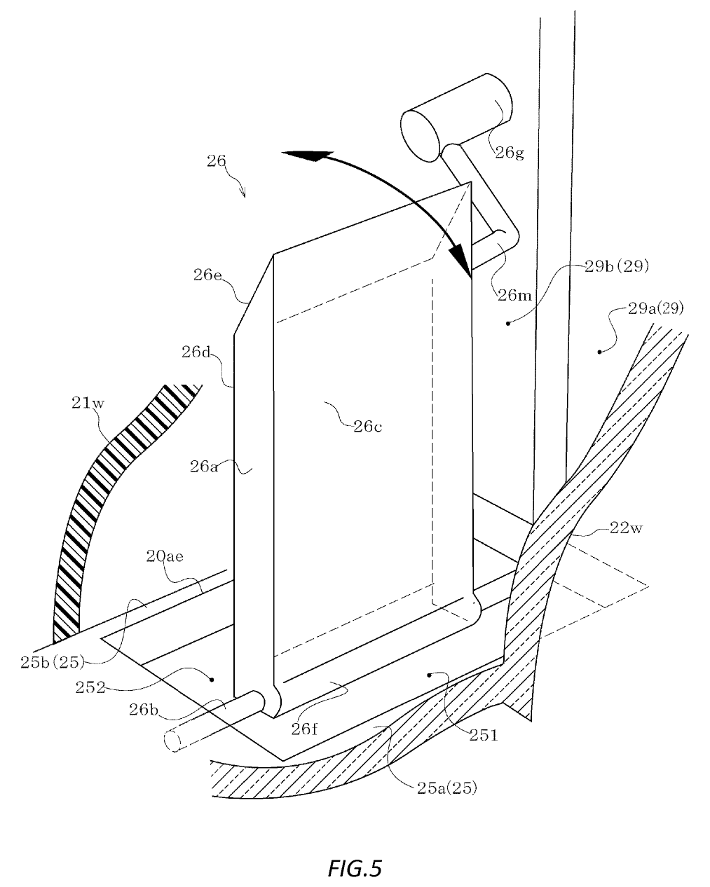

FIG. 5 is an enlarged perspective view of the sorting portion 26 shown in FIG. 3. As shown in FIG. 5, the sorting portion 26 includes: a plate portion 26a of a rectangular shape; a shaft portion 26b which rotatably supports the plate portion 26a; a weight 26g which is held by an arm 26m which projects from an end surface of the plate portion 26a; and an inclined surface 26e for directing which is formed on an upper portion of the plate portion 26a.

The sorting portion 26 includes: a first surface portion 26c, and a second surface portion 26d on the opposite side of the first surface portion 26c, for abutting the coins C that fall from above and sorting the coins C into the left and right. The first surface portion 26c guides the coin C that abuts this surface to be held on a first holding portion 25a side. On the other hand, the second surface portion 26d guides the coin C that abuts this surface to be held on a second holding portion 25b side. For example, in a free state, the sorting portion 26 is inclined by the weight 26g such that the first surface portion 26c faces upward (left side in FIG. 6), and guides the falling coin C to the first holding portion 25a side. On the other hand, under a predetermined condition described later (refer to FIG. 6), a rotation is performed such that the second surface portion 26d faces upward (right side in FIG. 6), thereby guiding the falling coin C to the second holding portion 25b side.

FIG. 6 is a schematic cross-sectional view of a vicinity of the sorting portion 26 as viewed from a rear side toward a front side of the apparatus. The sorting portion 26 is biased in the counterclockwise direction in FIG. 6 by the weight 26g, and is inclined such that an upper end part is in contact with the first side wall portion 21w in a free state in which no external force is applied. In this state, the coin C that falls from above abuts the first surface portion 26c, passes through the opening 20ae and falls into the first passage portion 251.

In the coins C that fall into the first passage portion 251, the last coin C of a prescribed number is held directly below the sorting portion 26 as illustrated. Then, by this last held coin C, the sorting portion 26 is maintained in a state of being rotated in the clockwise direction against the biasing force of the weight of 26g. That is, an upper end part of the coin C abuts a lower end portion 26f of the sorting portion 26, thereby maintaining the sorting portion 26 in a state in which an upper end portion thereof is close to a second side wall portion 22w side. In this state, it is possible to sort the coin C into the second holding portion 25b side. It should be noted that for a configuration in which the position of the coin C is regulated in the width direction thereof such that the coin C contacts the lower end portion 26f, the illustration shows a configuration in which a protrusion portion is provided on the second side wall portion 22w side. However, the configuration for this position regulation is not particularly limited as long as it can regulate the position of the coin C to the left side of the first passage portion 251 in the figure.

In addition, in a state in which the upper end portion of the sorting portion 26 is rotated to the second side wall portion 22w side, the inclination angle thereof is in a state of being closer to the vertical direction compared to a state of being inclined to a first side wall portion 21w side. However, at the upper end portion, the inclined surface 26e for directing the coin C to a second surface portion 26d side is formed, thereby making the movement of the coin C smooth.

The lower end portion 26f of the sorting portion 26 has a shape protruding toward a first passage portion 251 side below the shaft portion 26b. For example, as illustrated, it may be configured to have a protruding shape protruding toward the first passage portion 251 side, or to be bent to protrude toward the first passage portion 251 side.

In addition, the sorting portion 26 is configured to use the weight 26g for the biasing, but may be configured to use a biasing force of a magnet instead of the weight 26g.

In addition, on the second holding portion 25b side, a switch portion 27 which is configured to be capable of opening and closing the opening 20ae to regulate sorting, is provided. This switch portion 27 includes a horizontal plate portion 27a which is flat and which opens and closes the opening 20ae on the second holding portion 25b side, and an operation piece 27b which protrudes upward and laterally (left direction) from the horizontal plate portion 27a. Furthermore, the switch portion 27 is provided to be slidable (reciprocally movable) from the back side of the unit in the unit thickness direction. In this switch portion 27, the horizontal plate portion 27a is positioned in the second passage portion 252 directly below the opening 20ae, and can open and close the opening 20ae on the second passage portion 252 side. For example, as illustrated, when the switch portion 27 is in a first state P1 (left side in the figure) of being away from the first holding portion 25a, the opening 20ae is opened, enabling the inserted coins C to be sorted into both of the first and second holding portions 25a, 25b. On the other hand, when the switch portion 27 is in a second state P2 (right side in the figure) of being close to the first holding portion 25a, the opening 20ae on the second passage portion 252 side is closed, and the inserted coin C is not sorted into the second passage portion 252 but is sorted only into the first passage portion 251.

Above the second passage portion 252 (second holding portion 25b), a discharge portion 29 (29b) is provided, which is configured parallel to the second passage portion 252 and has an upper end side and a lower end side that are opened. That is, the discharge portion 29 (29b) constitutes an inclined path that is opened to the front of the unit from the space in which the sorting portion 26 is provided (refer to FIG. 4).

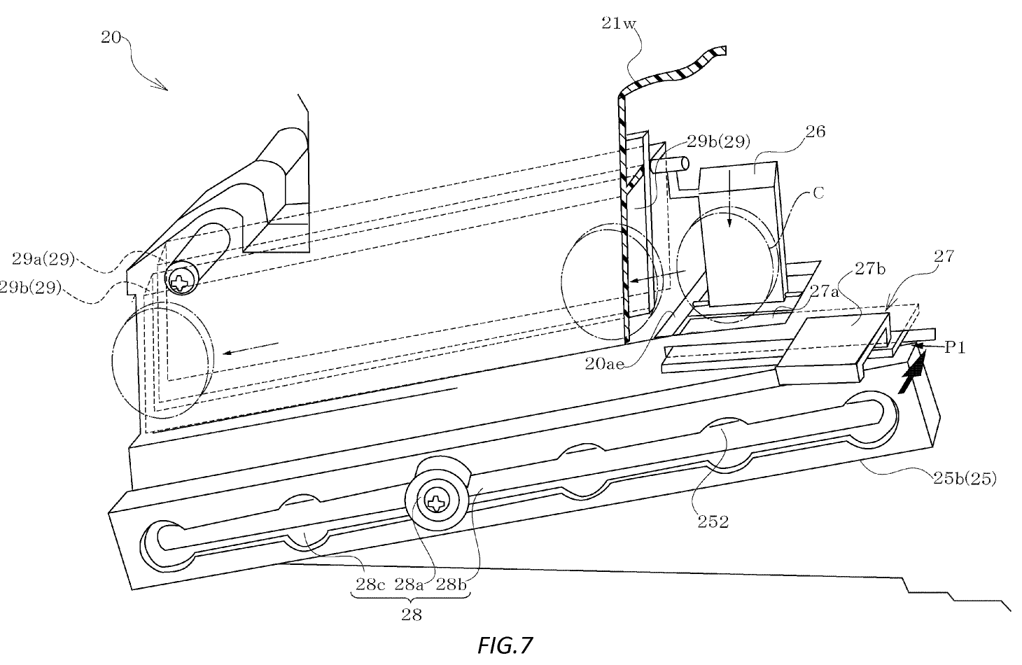

FIG. 7 is a schematic perspective view showing an example when the coin C is discharged. For example, the case where the coin C is discharged from the discharge portion 29 (29b) corresponds to a case where in the first state P1 in which the switch portion 27 causes the coin C to be held only in the first holding portion 25a, as shown in FIG. 7, the horizontal plate portion 27a of the switch portion 27 is closing the opening 20ae on the second holding portion 25b side. In this case, a prescribed number of coins C are held in the first holding portion 25a, thereby maintaining the sorting portion 26 in a state of being rotated in the clockwise direction by the last coin C (refer to FIG. 6). In this state, when the coin C is additionally inserted, it is sorted to the second holding portion 25b side by the sorting portion 26. However, the opening 20ae is closed by the horizontal plate portion 27a, and thus the coin C abuts the horizontal plate portion 27a and is discharged to a return port 6 through the discharge portion 29 (29b).

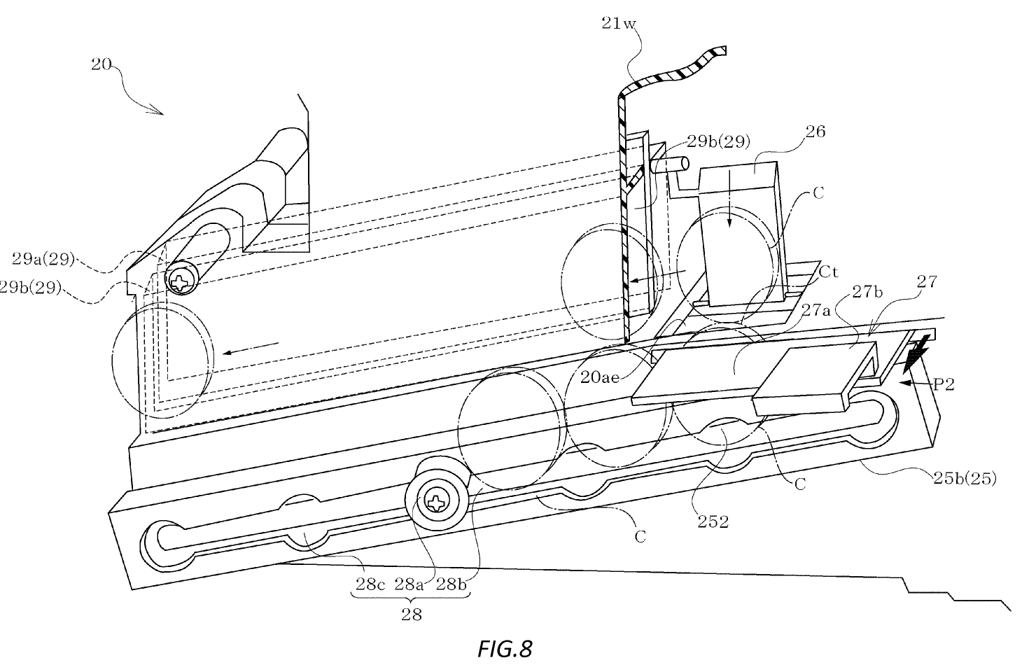

FIG. 8 is a schematic perspective view showing another example when the coin C is discharged. Another case where the coin C is discharged from the discharge portion 29 (29b) will be described. For example, this case corresponds to the second state P2 in which the switch portion 27 is capable of causing the coins C to be held in both of the first holding portion 25a and the second holding portion 25b. In this case, a prescribed number of coins C is held in the first holding portion 25a, and then the coin C is held in the second holding portion 25b. Then, when the prescribed number of coins C are held in the second holding portion 25b, as shown in FIG. 8, the last (rearmost) coin C is positioned at the opening 20ae. That is, an upper end portion Ct of the last coin C functions as a part of the passage to block the opening 20ae, whereby the coin C that is additionally inserted is brought into contact with the upper end portion Ct of the coin C and is discharged to the return port 6 through the second discharge portion 29b.

It should be noted that a first discharge portion 29a which is the same as the second discharge portion 29b is also provided above the first passage portion 251 (first holding portion 25a). In addition, a return button 7 is provided below the insertion portion 5. For example, when a user wants return of the coin C which is already inserted, or the like, it is possible, by pressing the return button 7, to discharge the coins C held in the first holding portion 25a and the second holding portion 25b, to the return port 6.

As described above, the article supply apparatus 1 of the present aspect includes the discharge portion 29 which is capable of discharging the inserted coin C, thereby making it possible to discharge, from the discharge portion 29 to the outside of the machine, the excess coin C that is additionally inserted, on the condition that the holding portion is holding a prescribed number of coins C which is set in advance by the setting portion 28. Accordingly, with the present embodiment, it is possible to provide the article supply apparatus which easily discharges the excess coin with improved convenience.

In addition, in the present aspect, when the excess coin C is discharged, the switch portion 27 which switches the coin holding mode of the holding portion 25, the sorting portion 26 which sorts the coin, and the setting portion 28 which sets the number of coins that are held, can function as a control portion in association with one another. Accordingly, electrical control is not necessary, and it is possible to provide the article supply apparatus 1 including a mechanism capable of handling the excess coin with a simple configuration.

In the article supply apparatus 1 of the present aspect, the holding portion 25 which holds the inserted coins C, includes the first holding portion 25a and the second holding portion 25b, thereby making it possible to hold the coins C in a plurality of locations, making it possible to diversify the coin holding mode, and making it possible to increase the number of coins that are held.

In the article supply apparatus 1 of the present aspect, the second holding portion 25b is configured to be capable of holding the coin C that is additionally inserted, on the condition that the first holding portion 25a is holding a set number of coins C for the first holding portion 25a, thereby making it possible to set a price that cannot be fully held in the first holding portion 25a.

In the article supply apparatus 1 of the present aspect, it is possible to switch, by the operation of the switch portion 27, between the first state P1 in which the coin C is held only in the first holding portion 25a and the second state P2 in which the coins C are held in the first holding portion 25a and the second holding portion 25b, and it is possible to easily switch the coin holding mode and the number of coins that are held.

In the article supply apparatus 1 of the present aspect, the first holding portion 25a and the second holding portion 25b are provided at positions facing each other on the front and back sides of the unit, and thus the arrangement of the switch portion 27 is easy. In addition, both holding portions are provided inclined with respect to the horizontal in a longitudinal direction, thereby making it possible to move the coin C downward.

In the article supply apparatus 1 of the present aspect, the discharge portion 29 (second discharge portion 29b) is provided on the upper side of the second holding portion 25b side (upper side in the direction of coin C falling), thereby making it possible to discharge the coin C from the second discharge portion 29b, just before it falls into the second holding portion 25b.

In the article supply apparatus 1 of the present aspect, when the position of the switch portion 27 is in the first state P1 and a prescribed number of coins C are held in the first holding portion 25a, the coin C is sorted into the second holding portion 25b side by the sorting portion 26, and the entrance (opening 20ae) of the second holding portion 25b is closed, thereby making it possible to discharge the additional excess coin C from the second discharge portion 29b.

In the article supply apparatus 1 of the present aspect, when a prescribed number of coins C are accommodated in the first holding portion 25a and the second holding portion 25b, the last coin C in the second holding portion 25b blocks the entrance (opening 20ae) of the second holding portion 25b, constituting the passage (bottom part of the passage) of the second discharge portion 29b, whereby the coin C that is additionally inserted is sorted to the second holding portion 25b side, and then is brought into contact with the last coin C held in the second holding portion 25b, and can be discharged from the second discharge portion 29b.

In the article supply apparatus 1 of the present aspect, the counterfeit coin C (improper coin C) is captured by the movement regulation portion 23 provided in the passage portion 20a through which the coin C moves, and thus it is possible for the first holding portion 25a and the second holding portion 25b not to hold the counterfeit coin C.

While an aspect of the present invention has been described hereinabove, the present invention can be appropriately altered in the scope of its technical idea. For example, the above aspect describes the configuration provided in the article supply apparatus 1 for selling the articles P of the capsule case, but the present disclosure is not limited to this, and can be applied to various apparatuses for selling articles.

### Description of Symbols

1: article supply apparatus;

5: insertion portion;

20a: passage portion;

23: movement regulation portion

25: holding portion;

25a: first holding portion;

25b: second holding portion;

26: sorting portion;

27: switch portion;

28: setting portion;

29: discharge portion;

29b: second discharge portion;

C: coin;

P1: first state;

P2: second state.

What is claimed is:

1. An article supply apparatus comprising:
an insertion portion to which a coin is insertable;
a holding portion which is capable of holding the coin that is inserted;
a setting portion which is capable of setting a number of at least one coin capable of being held in the holding portion;
a discharge portion which is capable of discharging the coin that is inserted; and
a control portion capable of controlling whether or not to discharge the coin that is inserted, wherein
the control portion controls the coin that is additionally inserted to be discharged to the discharge portion, on a condition that the holding portion is holding a set number of coins.

2. The article supply apparatus according to claim 1, wherein
the holding portion includes a first holding portion and a second holding portion, and
each of the first holding portion and the second holding portion is configured to be capable of holding a plurality of coins.

3. The article supply apparatus according to claim 2, wherein
the second holding portion is configured to be capable of holding the coin that is additionally inserted, on a condition that the first holding portion is holding a set number of the coins for the first holding portion.

4. The article supply apparatus according to claim 3, wherein
the first holding portion is configured such that only the first holding portion is capable of holding the coin, on a condition that a set number of coins which is capable of being held for the second holding portion is zero.

5. The article supply apparatus according to claim 4, wherein
the second holding portion is configured not to hold the coin, on a condition that a set number of coins which is capable of being held for the first holding portion is zero.

6. The article supply apparatus according to claim 2, further comprising:
a switch portion which is capable of switching between a first state in which the coin is held only in the first holding portion and a second state in which the coins are held in the first holding portion and the second holding portion.

7. The article supply apparatus according to claim 6, wherein
the first holding portion and the second holding portion are provided inclined with respect to the horizontal in a longitudinal direction at positions facing each other.

8. The article supply apparatus according to claim 7, wherein
the discharge portion includes a second discharge portion which is provided on a side of the second holding portion.

9. The article supply apparatus according to claim 8, wherein
the control portion controls the coin that is additionally inserted to be discharged from the second discharge portion, on a condition that the switch portion is in the first state and the first holding portion is holding a set number of the coins.

10. The article supply apparatus according to claim 9, wherein
the control portion controls the coin that is additionally inserted to be discharged from the second discharge portion, on a condition that the switch portion is in the second state, the first holding portion is holding a set number of the coins, and the second holding portion is holding a set number of the coins.

11. The article supply apparatus according to claim 10, wherein
the control portion controls the coin that is additionally inserted, to be caused to contact the coin that is held in the second holding portion, and then to be discharged from the second discharge portion, on a condition that the switch portion is in the second state, the first holding portion is holding a set number of the coins, and the second holding portion is holding a set number of the coins.

12. The article supply apparatus according to claim 11, wherein
the control portion controls the coin that is to be discharged from the second discharge portion, not to be caused to contact the coin that is held in the first holding portion, and to be discharged from the second discharge portion.

13. The article supply apparatus according to claim 12, wherein
the coin that is held in the second holding portion is configured as a part of a passage through which the coin that is additionally inserted is capable of passing.

14. The article supply apparatus according to claim 2, wherein
the coin includes a proper coin and an improper coin, and
the first holding portion and the second holding portion are configured to be capable of holding the proper coin, and not to hold the improper coin.

15. The article supply apparatus according to claim 14, further comprising:
a passage portion through which the coin that is inserted is movable, wherein
the passage portion includes a movement regulation portion which regulates a movement of the improper coin that is inserted.

16. The article supply apparatus according to claim 3, further comprising:
a switch portion which is capable of switching between a first state in which the coin is held only in the first holding portion and a second state in which the coins are held in the first holding portion and the second holding portion.

17. The article supply apparatus according to claim 4, further comprising:
a switch portion which is capable of switching between a first state in which the coin is held only in the first holding portion and a second state in which the coins are held in the first holding portion and the second holding portion.

18. The article supply apparatus according to claim 3, wherein
the coin includes a proper coin and an improper coin, and
the first holding portion and the second holding portion are configured to be capable of holding the proper coin, and not to hold the improper coin.

19. The article supply apparatus according to claim 4, wherein
the coin includes a proper coin and an improper coin, and
the first holding portion and the second holding portion are configured to be capable of holding the proper coin, and not to hold the improper coin.

20. The article supply apparatus according to claim 5, wherein
the coin includes a proper coin and an improper coin, and
the first holding portion and the second holding portion are configured to be capable of holding the proper coin, and not to hold the improper coin.
